(19) United States
(12) Patent Application Publication
(10) Pub. No.: US 2005/0212829 A1
(43) Pub. Date: Sep. 29, 2005

(54) Thermal printing head comprising a guide member for the print tape configured as protective cover for a flexible control printed circuit board

(76) Inventor: Denis Montagutelli, Angers (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/508,518

(22) PCT Filed: Mar. 19, 2003
(86) PCT No.: PCT/FR03/00875

§ 371 Date: May 25, 2005

(30) Foreign Application Priority Data
Mar. 21, 2002 (FR) 02/03505

(51) Int. Cl. G01D 15/00

(52) U.S. Cl. 346/145

(57) ABSTRACT

The invention relates to a thermal printing head comprising a printable tape guiding member (4) which is monobloc and formed into a staple comprising two superimposed walls (8, 9) for covering, at least partially, respectively and jointly, both faces of the flexible printed circuit (3), said superimposed walls (8,9) providing therebetween a space for the passage of the guiding wing (6) of the supporting board, enveloped by the flexible printed circuit (3), so that the shaping of the guiding member (4) into a staple enables elastic embedding thereof on the guiding wing (6) of the supporting board (1) and enables to protect the flexible printed circuit (3) in its junction zone with the supporting board (1), and so that, one of the walls (8) of the guiding member (4) including fingers (11, 21) for bearing locally on the flexible printed circuit (3), an electric contact is established between the flexible printed circuit (3) and the supporting board (1), for grounding the printing head by dint of the flexible printed circuit (3).

The invention relates to the field of thermal printing machines, notably applicable to payment terminals. Its object is a member for guiding a tape to be printed, fitting a printing head for such machines.

Thermal printing mechanisms are known, which include a supporting board accommodating means for driving a tape to be printed against a thermal printing head, and means for controlling the dynamic members of the mechanism from remote control means. Among those mechanisms, those whereof the printing head includes a rigid supporting board, carrying a printing member made of ceramic material and of a printable tape guiding member, are known more particularly. The control means are formed, according to diverse variations, either of a rigid plate fixed to the supporting board, said rigid plate incorporating a printed circuit, or of a flexible printed circuit within which is embedded such a circuit, whereas the flexible printed circuit is fixed to the printing member by means of spikes or welded thereto, notably.

The difficulties to overcome in the field lie in a structural organisation of the printing head which should be simple and with small space requirements. Consequently, a preferred solution consists in using a flexible connector for the control means. However, the fragility of the flexible printed circuit, and its tricky link with the printing head, and notably with the printing member, tend to affect the advantages offered by their use, by reason of particular arrangements of the printing head aiming to protect the flexible printed circuit and to secure, possibly reinforce, its link with the printing head.

Besides, a general problem to solve lies in grounding the various members partaking of the printing mechanism. More particularly as regards the printing head, the former is especially fragile and might be damaged further to electrostatic discharges from the surrounding elements, which said head supports and/or includes, including the tape to be printed.

It has been suggested by the document EP 0729839 (ROHM CO Ltd) to add-on by embedding on the supporting board, a metallic guiding member for the tape to be printed, said guiding member comprising spikes extending across a rigid printed circuit forming the printing head control means, by dint of the openings that it includes. These spikes enabling to provide an electric contact between the conducting supporting board and the guiding member, which is also conducting, and hence between the supporting board and the tape to be printed, with a view to evacuating the static electricity transported by said tape.

The general purpose of the present invention is to provide simple arrangements of the printing head to remedy all the shortcomings aforementioned. More precisely, it is an object of the present invention to organise the structure of the printing head in order to make the structure thereof as straightforward as possible and with the smallest space requirements, such organisation enabling moreover easier protection of its sensitive members, notably the printing member and the control means from a mechanical viewpoint as well as from the point of view of the electrostatic charges transported by the various members involved therein.

More particularly, a first specific aim of the present invention is to provide a thermal printing head in order to secure the mechanic link of the different elements involved therein and in order to protect the sensitive members thereof, control means and printing member notably, such arrangement not being detrimental to simplification of its organisation nor to its small space requirements.

More particularly still, a second aim of the present invention is to provide a thermal printing head whereof the simple organisation and the small space requirements enable to implement specific configurations to protect its sensitive members against the electrostatic charges present in its environment when in use.

The thermal printing head of the present invention is intended for fitting a printing mechanism of a tape to be printed, as applicable to the payment terminals.

This printing head includes a rigid supporting board carrying a printing member made of ceramic material, a member for guiding a tape to be printed and means for controling the printing head. The guiding member is added to the rigid supporting board by embedding.

According to a first approach of the present invention, the control means are composed of a flexible printed circuit fixed to the printing member. The supporting board comprises a wing for guiding the flexible printed circuit, around which it extends partially from one large face to the other large face thereof. The guiding member, for its own part, is advantageously arranged into a protection cover for the supporting board guiding wing surrounded by the flexible printed circuit. The guiding member is advantageously added to the guiding wing by embedding, notably resilient embedding, in order to cap at least partially and jointly the flexible printed circuit and the large opposite faces of the guiding wing. These configurations are such that the flexible printed circuit is oriented with a 180° corner turning from its fastening zone to the printing member towards the outside of the printing head, while remaining protected by the guiding member.

According to an advantageous embodiment, the guiding member is formed advantageously and globally into a staple, whereas its embedding assembly on the supporting board is performed at least by pinching the guiding wing using the guiding member between the tabs opposite the staple, which are preferably mobile elastically or which include, similarly, elastically antagonist members.

According to a second approach of the present invention, the control means are formed of a flexible printed circuit fixed to the printing member which is used for grounding the supporting board from a contact established between a bare zone of the flexible printed circuit and the supporting board, and/or similarly between a bare zone of the flexible printed circuit and the control member, itself in electric contact with the supporting board. This electric contact is caused by corresponding localised pression exerted on the flexible printed circuit by at least one finger included in the guiding member.

It should be noted that the organisation aforementioned of the mechanical link between the guiding member on the one hand the flexible printed circuit and the supporting board on the other hand, enables advantageously to provide simple contact between the supporting board and the flexible printed circuit, from the guiding member.

According to this second approach of the present invention, the printing head is of the type wherein the guiding member is added to the supporting board in order to provide an electric contact therebetween, for at least evacuating the electrostatic charges transported by the tape to be printed. It should be understood that the guiding member and the supporting board are electrically conducting.

According to an aspect of the invention relating to this second approach, the control means are composed of a flexible printed circuit fixed to the printing member, and the printable tape guiding member is exploited for grounding the printing head by dint of a flexible printed circuit. This guiding member comprises advantageously at least one finger, in plurality notably, for bearing locally on the flexible printed circuit. This local bearing effect establishes an electric contact between the flexible printed circuit and any at least of the supporting board and of the guiding member, for grounding the printing head by dint of the flexible printed circuit.

It should be understood that the conducting character of any of the supporting board and of the guiding member may only limited structurally to their zones desired to be conducting.

It should be understood that according to an advantageous embodiment combining both approaches aforementioned, the inner face of the guiding member includes said localised bearing member, arranged on the corresponding tab of the staple.

According to a preferred embodiment of the supporting board, said supporting board includes a generally L-shaped profile. A first wing of the supporting board includes, superimposed, the printing member made of ceramic material, which is notably arranged as a plate. A second wing of the supporting board, concurrent to the former, and notably substantially orthogonal, forms the guiding wing of the flexible printed circuit.

The flexible printed circuit is preferably welded to the printing member, whereas the guiding member comprising advantageously at least one wall covering the flexible printed circuit, at least partially in its zone covering the supporting board. The covering wall which overlaps the flexible printed circuit in the vicinity of its welding zone, is provided with at least one member protecting the welding zones on the printing member of the flexible printed circus, and/or, if possible, of their immediate vicinity.

Embedding assembly of the guiding member on the supporting board is preferably a hardly reversible embedding, and preferably spontaneously irreversible, such as using a clip or similar.

For example, embedding assembly of the guiding member on the supporting board is comforted by a member for embedding the guiding member inside a recess matching the supporting board. It should be noted that the mechanical and electric link between the guiding member and the supporting board is accessorily completed by means of lateral walls of the guiding member, in contact with the corresponding edges of the supporting board.

The guiding member comprises preferably a relief facing a window of the supporting board, for letting through an optic signal from a member detecting the tape to be printed. It should be noted that, if needed, this relief of the guiding member also enables the passage of a protruding optic detection member, which is advantageously supported by the flexible printed circuit.

It should be observed that according to another aspect of the invention revealing another of its advantages, the configurations aforementioned, taken individually or in combination, may be obtained by simple arrangement of the printable tape guiding member and/or of the supporting board, which are formed independently by a monobloc element.

According to a fist embodiment of this arrangement, any of the supporting board and/or of the guiding member is formed by cutting and folding a metal sheet

According to a second embodiment variation of this arrangement, any of the supporting board and/or of the guiding member is formed by moulding a conducting plastic material, the latter being either charged or provided with a conducting coating in order to be globally conducting, or incorporating conducting members embedded during the moulding operation.

The present invention will be understood better and relevant details will appear in the light of the following description of a preferred embodiment, in relation with the appended drawing figures, wherein:

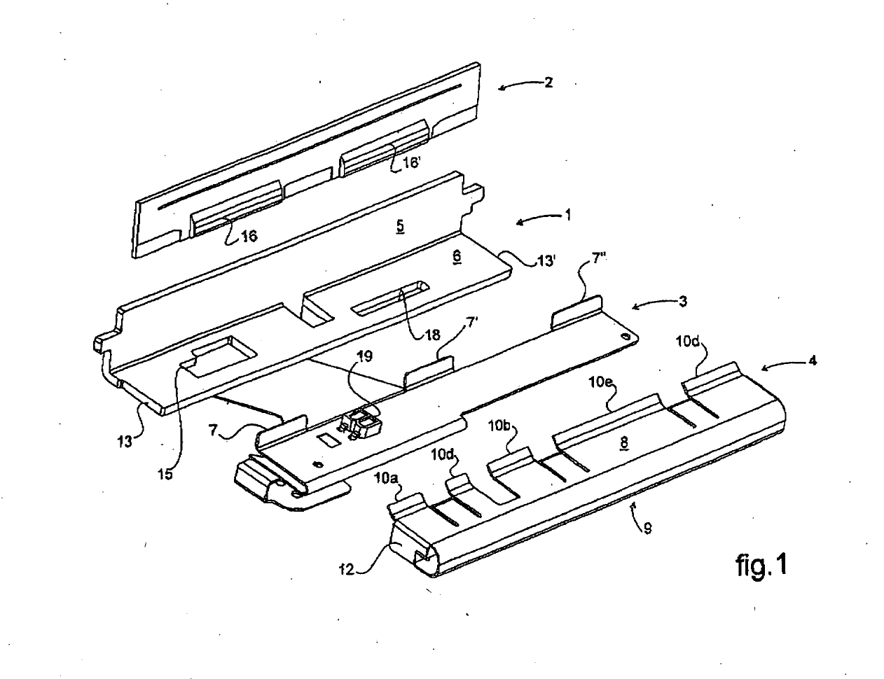

FIG. 1 is an exploded perspective, top view, of a printing head according to a first embodiment variation of the invention.

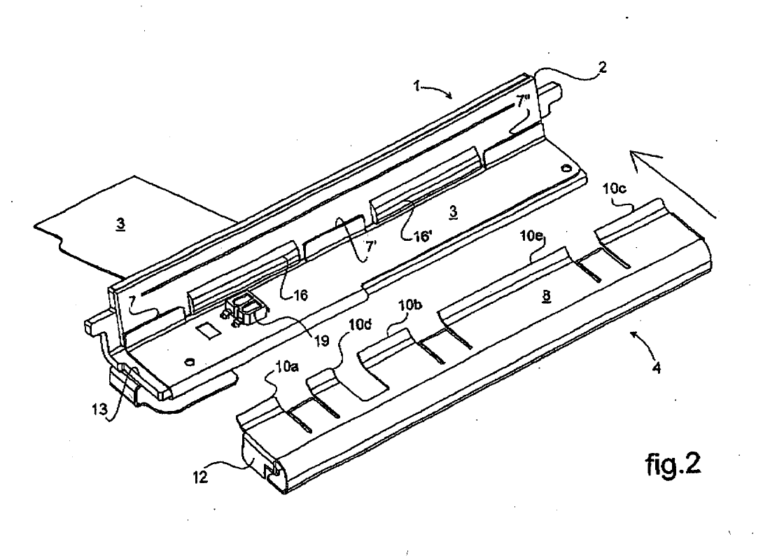

FIG. 2 is a perspective top view of the printing head represented on FIG. 1, partially assembled.

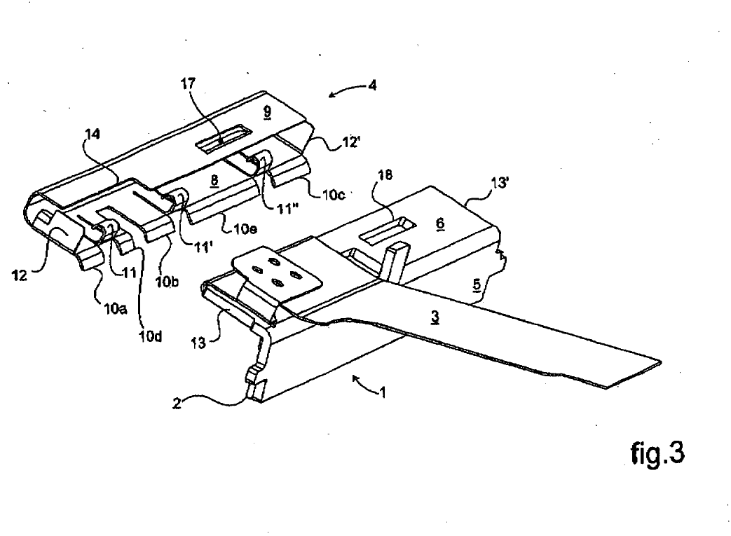

FIG. 3 is a perspective bottom view of the printing head represented on FIG. 1 and FIG. 2, partially assembled.

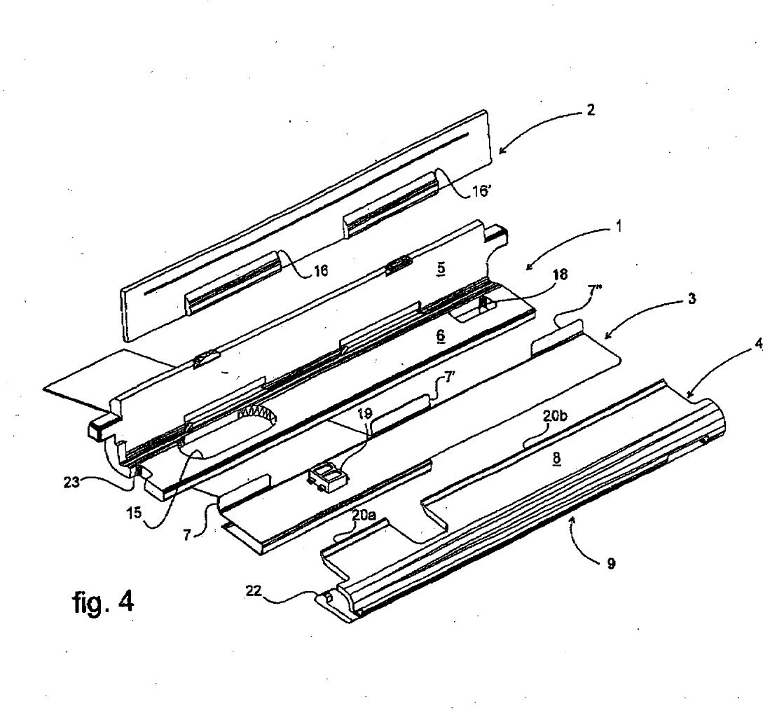

FIG. 4 is an exploded perspective, top view of a printing head according to a second preferred embodiment variation of the invention.

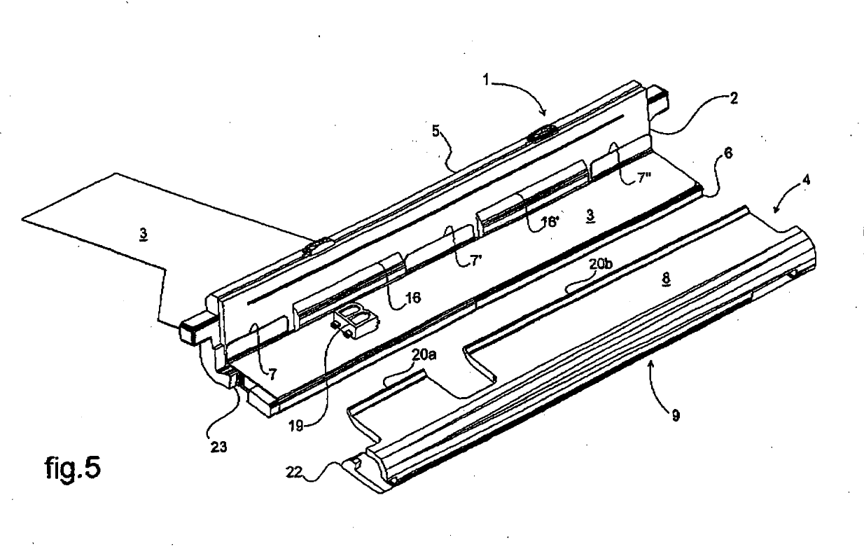

FIG. 5 is a perspective top view of the printing head represented on FIG. 1, partially assembled.

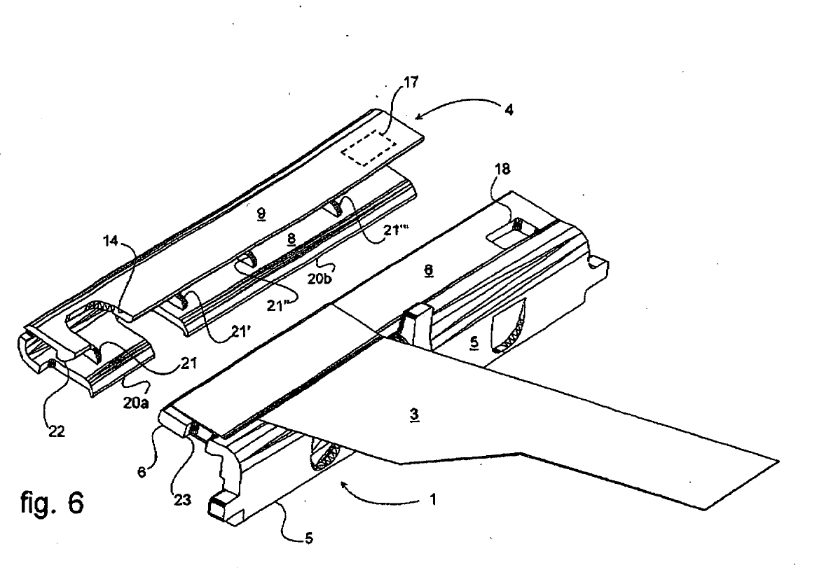

FIG. 6 is a perspective bottom view of the printing head represented on FIG. 1 and FIG. 2, partially assembled.

On the Figures, a thermal printing head is mainly composed of a live supporting board 1, of a printing member of ceramic material 2, of a flexible printed circuit 3 and of a guiding live member 4 for a running printable tape (not represented on the Figures).

The supporting board 1 includes two orthogonal wings 5 and 6, whereof a first wing 5 which is provided for supporting an insert 2 made of ceramic material, forming the printing member, and a second wing 6 which is provided to be enveloped by the flexible printed circuit 3, from one of its large faces to the other. The flexible printed circuit 3 comprises fastening tabs 7, 7′, 7″ for welding to the printing member 2. It appears that the 180° corner turning of the flexible printed circuit 3 from its fastening zone, prevents the welding zones from being exposed to an untimely tension liable to alter the fastening quality of the flexible printed circuit to the printing member.

The guiding member 4 is arranged as a protection cover of the flexible printed circuit 3, and includes to this end, two superimposed walls 8 and 9 to cover both faces of the flexible printed circuit 3 in contact with the second wing 6 of the supporting board 1.

The wall 8 covering the flexible printed circuit 3 in its fastening zone to the printing member 2 comprises members 10a, 10b, 10c, 10d, 10e (first variation, FIG. 1 to FIG. 3) or 20a, 20b (second variation, FIG. 4 to FIG. 6) for protecting the welding zones.

Certain zones of these protection members, possibly certain of these members properly speaking according to the first variation illustrated, are for example allocated to the protection of the welding zones of the flexible printed circuit 3 for increased tear strength; other zones of these protection members, possibly certain of these members properly speaking according to the first illustrated variation, are for example allocated to covering the vacant space between electronic members, such as 16, 16′, supported as protruding by the printing member 2, and the neighbouring edge of the corresponding wall 8 of the guiding member 4 covering the flexible printed circuit 3, to prevent the ingress of dirt or dust.

Besides, the guiding member 4 includes fingers 11, 11′, 11′ (first variation, FIG. 1 to FIG. 3) or 21, 21′, 21″, 21′″ (second variation, FIG. 4 to FIG. 6), for localised bearing on the flexible printed circuit 3. It should be understood that this localisation of the bearing fingers 11, 11′, 11″ or 21, 21′, 21″, 21′″ matches corresponding zones of the flexible printed circuit for grounding purposes. These bearing fingers enable to establish reliable electric contact between the supporting board 1 and the flexible printed circuit 3.

The guiding member 4 is in electric contact with the supporting board 1, by dint of at least one member 17 (first and second variations, FIG. 1 to FIG. 6) and/or 22 (second variation, FIG. 4 to FIG. 6) contained therein, for embedding inside a corresponding housing 18 and/or 23 of the supporting board 1. This electric contact is preferably enhanced by contacting the lateral walls 12, 12′ of the guiding member 4, with the matching edges 13, 13′ of the supporting board 1. Consequently, the printing head is grounded, including the running tape in contact with the guiding member 4.

The conducting supporting board 1 being liable to be in electric contact with the chassis of the printing mechanism (not represented on the Figures) which supports the head, the printing mechanism may therefore be grounded by the printable tape guiding member 4 bearing against the flexible printed circuit 3, for electric contact thereof 3 with the supporting board 1.

There should be observed on the guiding member 4, covering the flexible printed circuit 3, the presence of a relief 14 facing a corresponding window 15 of the supporting board 1. This relief 14 is provided for the passage of an optic member 19 supported by the flexible printed circuit 3, for detecting the presence of the printable tape, failing the signal thereof.

According to the first embodiment variation illustrated on FIG. 1 to FIG. 3, the supporting board 1 and the guiding member 4 are formed by cutting and folding a metal sheet.

The bearing fingers 11, 11′, 11″, the protection members 10a, 10b, 10c and 10d, and the embedding member 17 notably, extend from the walls 8 and 9 of the guiding member provided for covering the flexible printed circuit 3.

According to the second embodiment variation illustrated on the FIG. 4 to FIG. 6, the supporting board 1 and the guiding member 4 are formed by moulding a plastic material, made conducting by coating or charging, the bearing fingers 21, 21′, 21″, 21′″, the protection members 20a, 20b and the embedding members 17 and 23 notably, being formed when moulding the guiding member 4.

There will be recognised therefore in its entirety a printable tape guiding member 4 for a thermal printing head in that it is monobloc and formed into a staple comprising two superimposed walls 8 and 9 for covering, at least partially, respectively and jointly, both faces of the flexible printed circuit 3, said superimposed walls 8 and 9 providing therebetween a space for the passage of the guiding wing 6 of the supporting board, enveloped by the flexible printed circuit 3, so that the shaping of the guiding member 4 into a staple enables elastic embedding thereof on the guiding wing 8 of the supporting board 1 and enables to protect the flexible printed circuit 3 in its junction zone with the supporting board 1, including and advantageously in its welding zones to the printing member 2, and so that, one of the walls 8 of the guiding member 4 including fingers 11 or 21 for bearing locally on the flexible printed circuit 3, an electric contact is established between the flexible printed circuit 3 and the supporting board 1, for grounding the printing head by dint of the flexible printed circuit 3.

The guiding member 4 comprises moreover at least one embedding member 17, 12, 22 for mechanic and electric linkage with the supporting board 1, by dint of co-operating members 18, 13, 23 contained therein. The wall 8 of the guiding member 4 intended for covering the flexible printed circuit 3 in the vicinity of its fastening by welding to the printing member 2, comprises members 10 for protecting the welding zones.

The wall 9, facing the previous one 8, of the guiding member 4 comprises elastic bearing fingers 11, 11′, 11″ or 21, 21′, 21″ for obtaining electric contact between the supporting board 1 and the flexible printed circuit 3, for grounding the printing head.

1. A thermal printing head for printing mechanism of a printable tape, said head comprising a rigid supporting board carrying a printing member made of ceramic material, a printable tape guiding member and means for controlling the printing head, whereas the guiding member is added to the rigid supporting board by embedding,
wherein control means being composed of a flexible printed circuit fixed to the printing member, the supporting board comprises a wing for guiding the flexible printed circuit, around which it extends partially from one large face to the other large face thereof, the guiding member being arranged into a protection cover for this supporting board guiding wing surrounded by the flexible printed circuit and whereon the guiding member is added by embedding in order to cap at least partially and jointly the flexible printed circuit and the large opposite faces of the guiding wing included in the supporting board ,
so that the flexible printed circuit is oriented with a 180° corner turning from its fastening zone to the printing member towards the outside of the printing head, while remaining protected by the guiding member.

2. A printing head according to claim 1, wherein the guiding member is globally shaped into a staple, whereas its embedding assembly on the supporting board is performed at least by pinching the guiding wing using the guiding member between the tabs opposite the staple.

3. A printing head according claim 1, wherein the guiding member is added to the rigid supporting board by embedding in order to establish electric contact therebetween for at least evacuating the electrostatic charges transported by the printable tape, whereas the guiding member and the supporting board are conducting and the control means are composed of a flexible printed circuit fixed to the printing member, the printable tape guiding member comprises at least one finger for bearing locally on the flexible printed circuit, in order to establish electric contact between the flexible printed circuit and any at least of the supporting board and of the guiding member, for grounding the printing head by dint of the flexible printed circuit.

4. A thermal printing head according to claim 1, wherein the supporting board includes a generally L-shaped profile, whereof a first wing includes, superimposed, the printing member made of ceramic material, which is arranged as a plate, and whereof a second wing, concurrent to the former, makes up the guiding wing of the flexible printed circuit.

5. A thermal printing head according to claim 1, wherein the flexible printed circuit being welded to the printing member, the guiding member comprises at least one wall covering the flexible printed circuit, at least partially in its zone covering the supporting board, the covering wall which overlaps the flexible printed circuit in the vicinity of its welding zone being provided with at least one member protecting the welding zones of the flexible printed circuit on the printing member.

6. A thermal printing head according to claim 1, wherein the embedding assembly of the guiding member on the supporting board is comforted by a member for embedding the guiding member inside a recess matching the supporting board.

7. A thermal printing head according to claim 1, wherein the guiding member comprises a relief facing a window of the supporting board, for letting through an optic signal from a member detecting the tape to be printed.

8. A thermal printing head according to claim 1, wherein any of the printable tape guiding member and of the supporting bard is formed by cutting and folding a metal sheet.

9. A thermal printing head according to claim 1, wherein any of the printable tape guiding member and of the supporting bard is formed by moulding a live plastic material.

10. A printable tape guiding member for thermal printing head according to claim 1, which is monobloc and formed into a staple comprising two superimposed walls providing therebetween a space for the passage of the guiding wing of the supporting board, enveloped by the flexible printed circuit, so that the shaping of the guiding member into a staple enables elastic embedding thereof on the guiding wing of the supporting board and so that, one of the walls of the guiding member including fingers for bearing locally on the flexible printed circuit, an electric contact is established between the flexible printed circuit and the supporting board, for grounding the printing head by dint of the flexible printed circuit.
